(19) United States
(12) Patent Application Publication
(10) Pub. No.: US 2004/0031029 A1
(43) Pub. Date: Feb. 12, 2004

(54) Methods and systems for automatically updating software components in a network

(76) Inventors: Kyu-Woong Lee, Milpitas, CA (US); Manish Sheladia, Santa Clara, CA (US); Denis Flaven, Saint-Pierre d'Allevard (FR); Roque Scheer, Porto Alegre (BR)

Correspondence Address: HEWLETT-PACKARD COMPANY, Intellectual Property Administration, P.O. Box 272400, Fort Collins, CO, 80527-2400, US

(21) Appl. No.: 10/213,773

(22) Filed: Aug. 6, 2002

(51) Int. Cl. G06F 9/44; G06F 9/445

(52) U.S. Cl. 717/171; 717/176

(57) ABSTRACT

A computer-implemented method for updating a plurality of software components disposed on a plurality of networked devices, the plurality of networked devices being interconnected in a computer network. The method includes ascertaining from a database first update parameters associated with a first networked device of the plurality of networked devices. The method also includes sending via the network the first update parameters to a first local update agent disposed at the first networked device. The method further includes obtaining, using the first local update agent and the first update parameters, a first update file for updating software in the first networked device. Additionally, the method includes updating, using the first local update agent and the first update file, the software in the first networked device.

### BACKGROUND OF THE INVENTION

In a computer network, there may be hundreds or even thousands of networked devices all interconnected for communication purposes. These networked devices include, for example, routers, hubs, servers, workstations, desktop computers, laptop computers, printers, storage devices, printers and/or other output devices, and the like. As is well known, each of the networked devices may include many different hardware components, each of which may be furnished with software (such as system software, application software, firmware, driver, or the like) that may require updating from time to time. The software associated with each hardware component may be updated using one or more update file supplied by the respective manufacturer or by another party in accordance with a predefined update procedure. Updating is necessary in order to, for example, keep the software in proper working order, install new features, eliminate bugs and/or incompatibility issues, and the like.

In a relatively small network, e.g., a network having fewer than fifty networked devices, it is possible to perform the software updating tasks manually for all the networked devices in the computer network. In a small business, for example. there is ideally a binder or a database tracking information pertaining to all the networked devices and the various hardware and software components installed thereon. Typically, there is also a person or group of persons, collectively known as the system administrator, in charge of maintaining and updating the hardware and software associated with the networked devices in the computer network.

In theory, as the system administrator becomes aware of the existence of an update file for one of the software components in one or more of the networked devices. the system administrator may obtain that update file and install it in the appropriate networked device(s). In practice, system administrators often find it difficult to track all the different software components that exist in a network. Even if the system administrator has a well-organized database for tracking the different software components in a network, there is still a need to track the version number associated with each software component since different versions may require different update files and some version may not require an update at all. Thus, unless the system administrator is extra-vigilant, some software components may not be timely updated, increasing the risk of a system crash and/or other potentially fatal errors.

Furthermore, the manual process of updating a software package is quite inefficient. In the typical case, the system administrator needs to ascertain the version number of the existing software component and arrange to download or otherwise obtain the required update file(s) for that version of that software component. Typically speaking, the update file(s) may be downloaded into or obtained in the form of a removable media (such as a CD ROM or a diskette). The system administrator then needs to schedule with the user of the affected networked device for a convenient time for the update task.

At the scheduled time, the system administrator would manually carry tile removable media having, the appropriate update file(s) to the location where the affected networked device is located. For some networked devices, it is possible to keep the downloaded update file(s) on the network and access the update file(s) from the affected networked device itself. For example, the system administrator may keep the update file(s) on a networked disk drive and access the update file(s) electronically from the desktop computer that requires updating.

At any rate, the system administrator needs to install or execute the update file(s) at the affected networked device and wait for the installation or execution process to complete, which may take a significant amount of time. If the installation is successful, it is often necessary to reboot the affected networked device to allow to changes to take effect. Rebooting itself is also time-consuming. After updating is completed, the system administrator also needs to diligently note the latest version number of the software component and update his database so that the next time the same software component requires updating, the appropriate update file(s) can be obtained.

As can be appreciated from the foregoing, the manual update process is time-consuming and tedious for the system administrator. Nowadays, system administrators often find that a large part of their day is occupied with performing manual updating tasks, with a significant part of the time spent waiting for the installation process to complete and/or for the device to reboot. The problem is further exacerbated for larger organizations, which may employ computer networks having hundreds, thousands or tens of thousands of networked devices. In these large organizations, the manual software updating task for the thousands of software components is typically too large for any one single person to handle alone, particularly in view of the raw number of networked devices in use and the fact that each networked devices may have multiple software components therein. Thus, it is not unusual for some large organizations to suffer the cost of employing multiple employees full time for the express purpose of cataloging, updating and maintaining software on the large number of networked devices.

The inefficiency of the manual software updating process also has other costs. Since system administrators generally keep the same working hours as other employees in a typical organization, every time the system administrator performs software update on a networked device during working hours, that networked device is unavailable for productive use. If the networked device is a desktop computer required by another employee to perform work, for example, the disruption negatively impacts the productivity of that other employee as well. Over time, the cumulative cost of employing multiple employees to perform manual software updates and of disrupting the productive work of other employees during manual software upgrading can be quite significant.

### SUMMARY OF THE INVENTION

The invention relates, in one embodiment, to a computer-implemented method for updating a plurality of software components disposed on a plurality of networked devices, the plurality of networked devices being interconnected if a computer network. The method includes ascertaining from a database first update parameters associated with a first networked device of the plurality of networked devices. The method also includes sending via the network the first update parameters to a first local update agent disposed at the first networked device. The method further includes obtaining, using the first local update agent and the first update parameters, a first update file for updating software in the first networked device. Additionally, the method includes updating, using the first local update agent and the first update file, the software in the first networked device.

The invention relates, in another embodiment, to an arrangement for updating a plurality of software components disposed on a plurality of networked devices, the plurality of networked devices being interconnected in a computer network. The arrangement includes a database for storing update parameters associated with the plurality of networked devices. The update parameters includes at least a name for a first one of the plurality of software components and a version number associated with the name for the first one of the plurality of software components. The arrangement further includes a plurality of local update agents, each of the plurality of local update agents being disposed at one of the plurality of networked devices. There is also included a software update engine configured to send individual sets of the update parameters to individual ones of the plurality of local update agents at the plurality of network devices, wherein a first one of the plurality of local update agents disposed at a first one of the plurality of networked devices is configured to obtain, upon receiving a first one of the individual sets of the update parameters, a first update file using the first one of the individual sets of update parameters. The first update file represents a file containing data for updating a first one of the plurality of software components disposed at the first one of the plurality of networked devices.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a simplified prior art network, including an administrative console and a plurality of networked devices.

FIG. 2 shows some exemplary software components within a networked device.

FIG. 3 is an architectural diagram showing, in accordance with one embodiment of the present invention, the various components of the automatic software update system.

FIG. 4 shows, in accordance with one embodiment of the present invention, the more relevant components of the software update engine.

FIG. 5 illustrates, in one embodiment of the present invention, the more relevant modules of a group deployment component.

FIG. 6 illustrates, in one embodiment of the present invention, the more relevant modules of a local update agent disposed within the target networked device.

FIGS. 7A and 7B are flowcharts illustrating, in accordance with one embodiment of the present invention, the steps involved in automatically updating network software components.

### DETAILED DESCRIPTION OF THE PREFERRED EMBODIMENTS

The present invention will now be described in detail with reference to a few prefer recd embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In accordance with one aspect of the present invention, there are provided systems and methods for automatically updating software components disposed at the various networked devices in a computer network. In one embodiment of the invention, there is provided a system and method for allowing the system administrator to conveniently obtain, at an administrator console, information about the update needs of the software components in different networked devices in a network. Generally speaking, the administrator console may access an update parameters database that contains information pertaining to the different software components in the various networked devices. For each software component, the update parameters database may include the identification of the specific network device or network devices in which the software component may be found, as well as the current version number of the software component. Furthermore, the information in the update parameters database may also include information pertaining to any update file for that software component.

In one embodiment, the administrator console also has access to an update schedule, which may or may not be integrated with the update parameters database.

The update schedule specifies the time when an update for a particular software component in a particular networked device should be performed. Optionally, the update schedule may also include a priority classification for the update. When the scheduled time arrives to update a particular software component on a particular networked device, a software update engine (which may include one or more individual sub-engines) sends the update parameters regarding the update file, along with any other parameters relevant to the update, to a local update agent local to the particular networked device on which the software component to be updated is located. The information sent includes, for example, parameters indicating where in the network or on the Internet the actual update file may be found and downloaded.

The local update agent then obtains the update file. performs the installation as required (which may include rebooting the networked device after installation). The local update agent may also relay status information pertaining to the update process at the networked device to the administrator console and/or update the update parameters file. For example, if installation is successful, the latest version number of the software component may be kept current with the update parameters file so that the next time an update is required for that software component, the appropriate update file may be selected.

Since the software component information is automatically kept current at the update parameters file, the invention provides a simple, automatic and relatively error-proof way for the system administrator to keep track of the software components and their update needs. The centralization of the software component information in a computer database that is automatically kept current after each update minimizes the chance that a software component at a given networked device may be inadvertently missed due to human error.

Furthermore, since the local installation is accomplished via parameters automatically sent from the update parameters database at the scheduled time, the invention makes it simple for the system administrator to update different networked devices with different sets of parameters pertaining to different update files. Given the proliferation of third-party hardware and software and the fact that, for example, two desktop computers running the same operating system may require different video drivers, printer drivers, NIC card firmware, etc., the ability to schedule the system to automatically send parameters pertaining, to different update files to different networked devices at any arbitrary scheduled times and have the local update agents perform the actual update task remotely represent a tremendous saving in time and effort for the system administrator.

As mentioned, in one embodiment, the software update engine only needs to send update parameters and not the actual update files themselves to the local update agent. Accordingly, the amount of data sent from the centralized software update engine through the network to accomplish the update task is reduced. This enables the centralized software update engine to efficiently update a large number of networked devices with different update files without an undue amount of data traffic overhead.

Furthermore, the ability to use the local update agents local to the networked device under-going the update to obtain the actual required update files and to locally perform the installation tasks allows the burden associated with updating the network software components to be distributed. For example, if the update tiles were sent from a centralized source (such as from the centralized update engine), performance would be have been degraded since update files are generally quite lengthy, and it may take a significant amount of time to transmit all the update files to all the networked devices.

As another example, if the installation tasks were handled from a central location (e.g., from the centralized software update engine), the processing burden associated with processing a large number of updates using a single processing engine would have degraded performance. In contrast, the invention takes advantage of the distributed bandwidth in the network links and routers to allow the different networked device to more rapidly obtain their own required update files. Furthermore, the invention takes advantage of the distributed processing power in the networked devices to share the processing burden associated with updates.

Since the centralized update engine only has to send a small amount of update parameter data to a local update agent to accomplish the installation task, the centralized update engine can more efficiently serve the updating needs of a large number of networked devices. Additionally, since an update may be scheduled for automatic execution at any arbitrary time and execution happens automatically at the scheduled time without requiring human intervention, the invention allows an organization to minimize impact to productivity by scheduling an update only during the time when the affected networked device is either idle or in light demand (such as at midnight, for example).

In accordance with one embodiment of the present invention, it is recognized that given the proliferation of software and hardware components in the market, it is very difficult for a given system administrator to keep up with all the data communication specifies required to communicate with the vast number of software components for the purpose of performing the updating task as well as to keep up with all the specifics of different update procedures required to successfully perform the update. For example, a video driver by a given manufacturer may require a certain number of files executed in a particular sequence in order to successfully update the driver software, which may differ vastly from the file(s) and sequence of execution required to successfully update another video driver software. The files and sequence of execution may vary for different software components, different manufacturers, or even among different versions of the same software component.

Given this difficulty, it is recognized that often times. the only practical way to implement an automatic software updating system on a large scale is to leverage on different specialists and/or manufacturers to create and supply different specialized local update agents. The inventive architecture enables this by providing protocols and interfaces which hide the specific data communication and implementation details of the centralized software update engine and/or the update parameter database and/or the local update agents from one another. In this manner, the invention renders it possible for different specialists and/or manufacturers to create different local update agents without requiring those specialists and/or manufacturers to know the specific details pertaining to the centralized software update engine and/or the update parameters database and/or other local update agents. This, as long as a local update agent conforms with the provided protocols and interfaces, it can communicate with the centralized software update engine and/or the update parameters database to accomplish the software component update task.

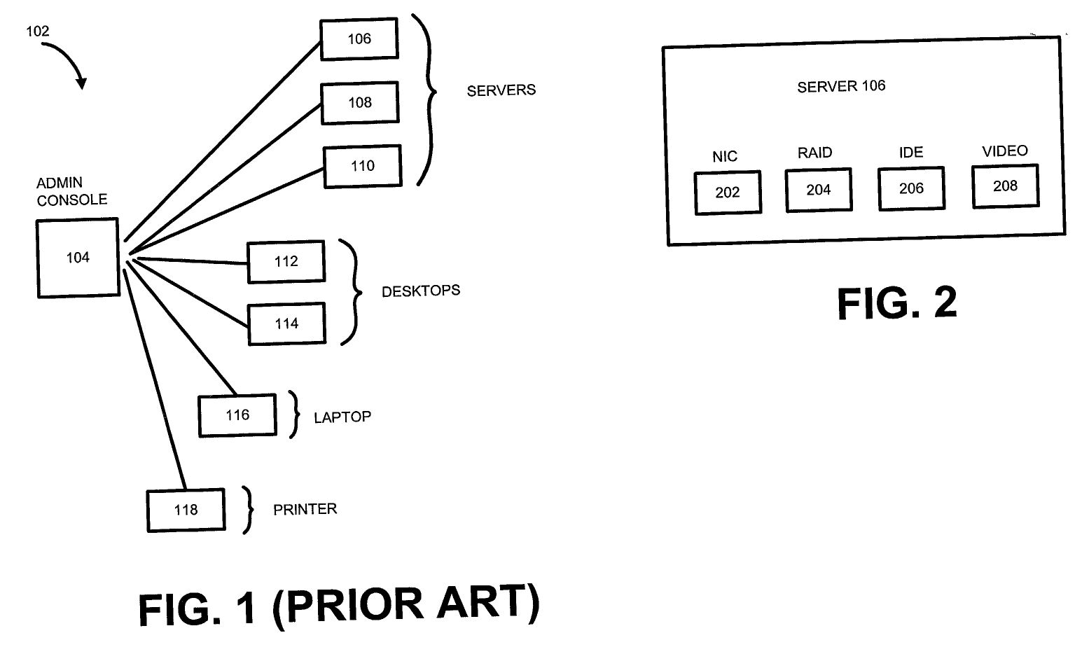

These and other features and advantages of the invention may be better understood with reference to the drawings and discussions that follow. To facilitate discussion, FIG. 1 shows a simplified prior art network 102, which includes an administrative console 104. Administrative console 104 is coupled via the network to a plurality of networked devices such as servers 106, 108, and 110. In the example of FIG. 1, servers 106, 108, and 110 represent servers running, for example, the Windows, Netware, and Linux operating systems respectively to illustrate that different networked devices may employ different software components therein. Administrative console 104 is also shown Coupled to desktop computers 112 and 114, as well as to a lap top computer 116 and a printer 118. In reality, a computer network may be coupled to any number and type of networked device in any topology (e.g., mesh, ring, star, and the like) to enable appropriate networked devices to communicate with one another.

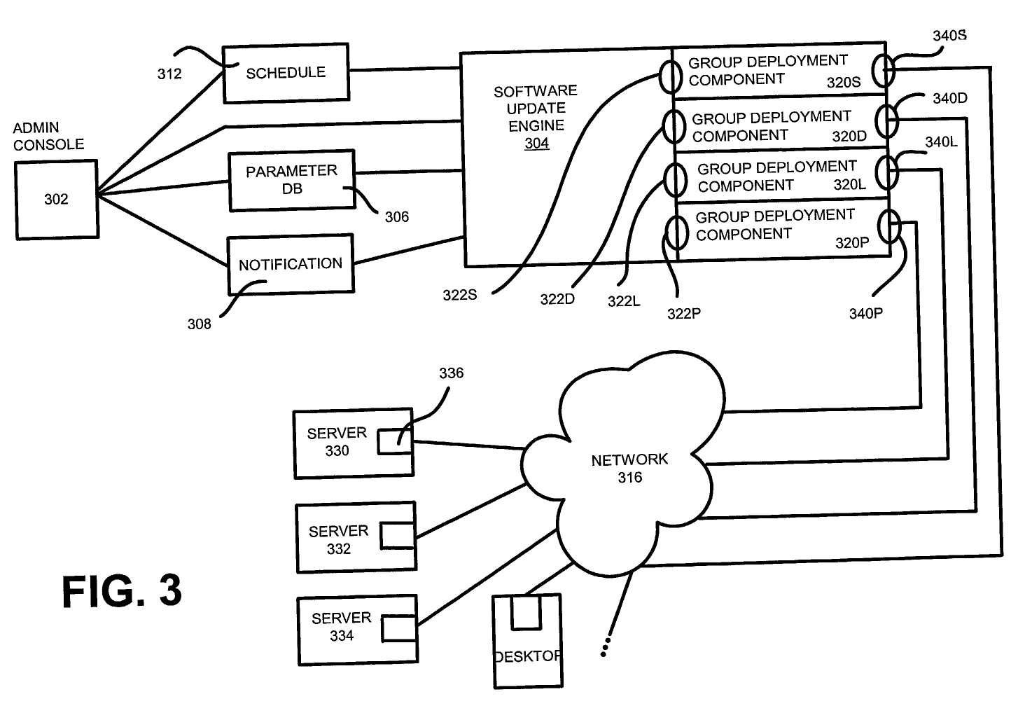

FIG. 2 shows some exemplary software components within a networked device, such those in server 106 of FIG. 1. In FIG. 2, server 106 may include a network interface card (NIC) driver 202, a redundant array of inexpensive disks (RAID) driver 204, an IDE drive controller 206, and a video driver 208. Other software components, including utilities, system software, application software, BIOS, etc. may also exist and they may also require updating, from time to time. One Should note that the software components may differ from network device to network device since different network devices may employ different hardware components from different manufacturers, or may employ the same hardware component but a different software component or even the same software component with a different version number. The point is that each networked device may have a unique set of software components that requires updating from time to time for proper maintenance and operation.

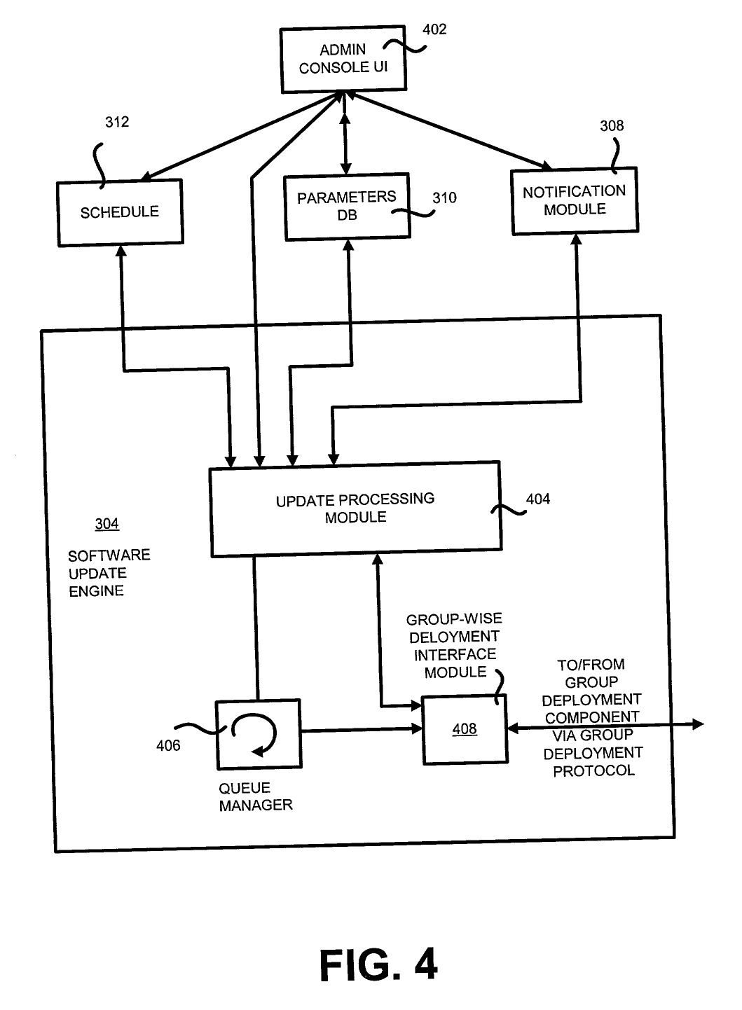

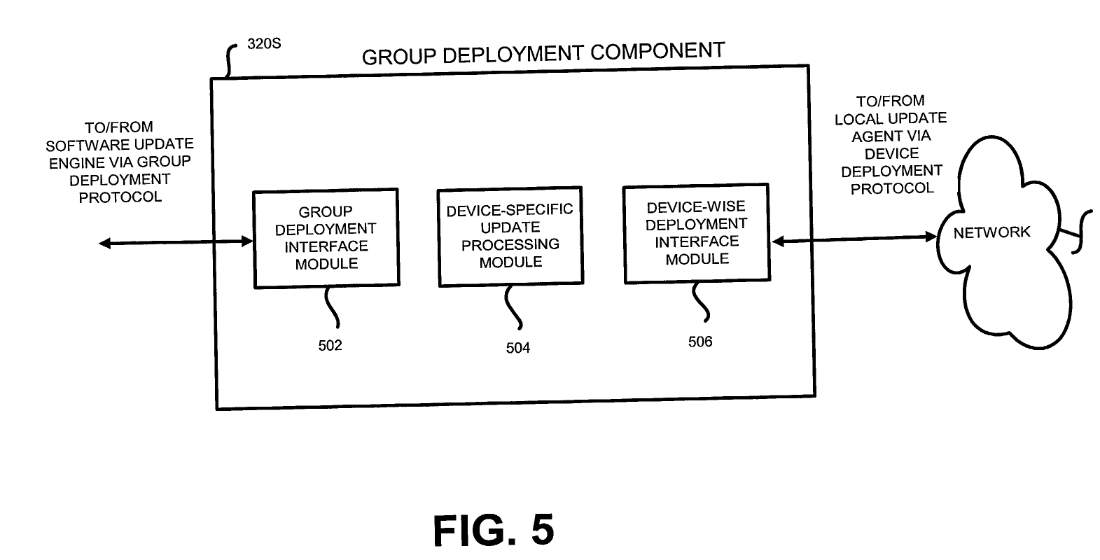

FIG. 3 is an architectural diagram showing, in accordance with one embodiment of the present invention, the various components of the automatic software update system. In FIG. 3, an administrative console 302 is typically employed by the human system administrator to interact with a software update engine 304. Software update engine 304 represents the logic for initiating the transfer, at a scheduled time, of appropriate update parameters to the networked device(s). Thus, one of the main tasks of software update engine 304 is to obtain the update parameters for the software components on the network, present these parameters to the system administrator for selection (if selection and/or filtering is desired), and compile update parameters responsive to the selections made by the system administrator in order to implement the updates selected. Software update engine 304 is discussed in greater detail in FIG. 4 herein.

Administrative console 302 is also shown communicably coupled to a database 306 and a notification module 308. Database 306 represents the database that contains the update parameters 310 for the software components in the network. For example, database 306 may include information about each software component, including its identification, its location in the network, its version number, and the like. Database 306 may also include parameters pertaining to one or more update files, if such exist, for the associated software component. Generally speaking, information pertaining to the update files may be obtained through subscription services from the component manufacturers themselves, or may be obtained via notification from a third party, or may be entered into the database by the system administrator staff if they happen to know of any required updates.

Database 106 may also include a schedule 312, representing a file or database tracking while the updates for individual software components would occur. Schedule 312 may be decoupled from database 106 in one embodiment or may be integrated therewith in another embodiment.

Notification module 308 represents the module for collecting the status information and/or notification messages from the various components of the automatic software update system. The notification messages may be sent to administrator console 302 and/or may be employed to automatically trigger other steps (which may be as simple as, for example, requesting the software update engine to reschedule the update 24 hours later if the target networked device is found to be offline during the initial update attempt).

Software update engine 304 is also shown coupled to a plurality of group deployment components 320S, 320D, 320L, and 320P. Each group deployment component controls the deployment of the update parameters to its respective group. For example, server group deployment component 320S may be responsible for the deployment of update parameters received from software update engine 304 to the appropriate servers, while desktop group deployment component 320D may be responsible for the deployment of update parameters received from software update engine 304 to the desktop computers. Likewise, laptop group deployment component 320L and printer group deployment component 320P may be responsible for the deployment of update parameters to the laptop computers and the printers respectively.

Grouping simplifies communication and implementation since networked devices in each type or group (such as those in the server group, the desktop group, the laptop group, the printer group, and the like) tend to have somewhat similar although not necessarily identical update requirements. Thus, a group of printers tend to have more in common as far as their update requirements than a printer and a desktop computer. The use of a group deployment component takes advantage of this fact and allows the software update engine to delegate some update-related tasks to the group deployment component. Furthermore, grouping facilitates modularity and modular development. Thus, the task of creating and maintaining each individual group deployment component may be assigned to those most familiar with the technology relevant to that group. By the same token, the people who develop the printer group deployment component, as an example, need not know how devices in other groups (such as desktops or laptops) may communicate with the software update

To improve flexibility and reliability, each group deployment component is coupled to software update engine 304 via a group deployment protocol 322. Any group deployment component may communicate with software update engine 304 as long as the group deployment protocol is followed. In this manner, any third party wishing to develop and furnish a group deployment component may do so easily. The use of a group deployment protocol hides the details of the particular software update engine from the group deployment components. Thus, if the software update engine itself is updated or changed, or if it is implemented on a different computer, there is no need to change the group deployment component.

Each group deployment component (such as server group deployment component 320S) is also shown coupled to its constituent networked devices (such as servers 330, 332, and 334) via the network 336. More to the point, each group deployment component is coupled to a plurality of local update agents, each of which is located at one of its constituent networked devices. Again, a group deployment component (such as server group deployment component 320S) may communicate with its counterpart local update agent (such as local update agent 336 at server 330) via a respective device deployment protocol 340. In this manner, any local update agent may communicate with its respective group deployment component as long as the device deployment protocol is followed.

The use of a device deployment protocol hides the details of the particular update agent from the group deployment component and/or the software update engine. Since it is expected that the local update agent may change significantly from software component to software component, and even from version to version of the same software component, the ability to modularize the specific details of a local update agent from the rest of the automatic software update system via a device deployment protocol greatly simplifies the task of integrating the various local update agents, which may be supplied by the various manufacturers of the update files, with the rest of the automatic software update system. Such modularization also improves flexibility and reliability and ensures that errors are localized, and an error with a given local update agent will not affect the other local update agents and tile remainder of the automatic software update system.

FIG. 4 shows, in accordance with one embodiment of the present invention, the more relevant components of software update engine 304 of FIG. 3. In FIG. 4, there is a shown a user interface module 402, representing the user interface component executing on the administrator console for allowing the administrator to interact with a notification module 308, an update parameters database 310, a schedule 312, and a software update engine 304. Notification module 308, update parameters database 310, and schedule 312 have been discussed earlier in connection with FIG. 3.

Software update engine 304 includes an update processing module 404, which receives the scheduling data from Schedule 312 as well as the update parameters pertaining to the network software components from update parameters database 310.

Update processing module 404 processes data from both scheduler 312 and update parameters database 310, as well as any selection input from the system administrator, to ascertain whether an update process should be initiated for one or more of the network software modules. As the scheduled time for updating a given software component arrives, update processing module 404 places the update parameters for that software component into a queue manager 406. Optionally, update processing module 404 may forward a notification message to notification module 308, which may then inform the system administrator that the update process has started for that particular software component.

Queue manager 406 may store update parameters for multiple software components and may send each set of update parameters out to the appropriate networked device via a group-wise deployment interface module 408. For each set of update parameters pertaining to a particular networked device, group-wise deployment interface module 408 sends that set of update parameters to appropriate group deployment component (shown in FIG. 3) in order to enable that set of update parameters to be eventually forwarded to the appropriate target networked device. By way of example, if the set of update parameters pertains to update information for a software component within a server, group-wise deployment interface module 408 would forward that set of update parameters to a server group deployment component (such as the server group deployment component 320S shown in FIG. 3).

To communicate between group-wise deployment interface module 408 and the individual group deployment components (such as 320S, 320D, 320L, or 320P in FIG. 3), group-wise deployment interface module 408 employs a group deployment protocol (shown by reference number 322 in FIG. 3). The use of a group deployment protocol enables any group deployment component that conforms to the group deployment protocol to communicate with the software update module, and more particularly to group-wise deployment interface module 408 within the software update engine.

Thus, the system administrator can confidently delegate the task of designing and coding each individual group deployment component to those familiar with the technology specific to a group (e.g., server technology for the server group deployment component) and as long as the group deployment component conforms to the group deployment protocol, that group deployment component can communicate to obtain the necessary update parameters from the group-wise deployment inter face module 408 in the software update engine.

On the other hand, the use of the group deployment protocol eliminates the need for those who design and code the individual group deployment components to also master the specifics of a particular software update engine. Again, all that is required is for the group deployment components to conform to the group deployment protocol. As a benefit, the software update engine may be implemented on a variety of hardware or software platforms without requiring changes in the individual group deployment components. In this manner, modularity, reliability, and flexibility are substantially enhanced.

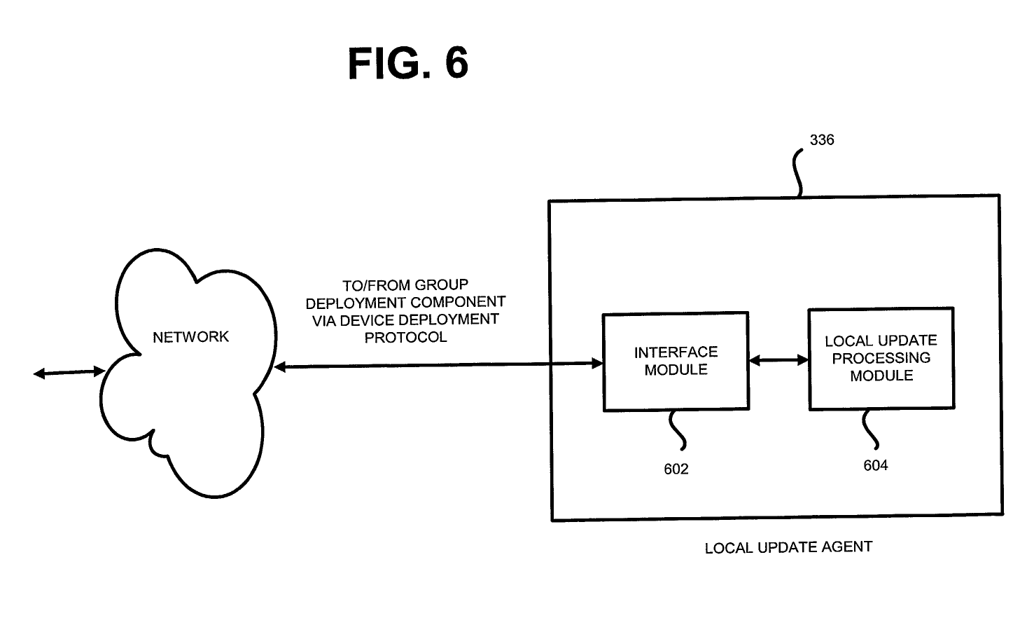

FIG. 5 illustrates, in one embodiment of the present invention, the more relevant modules of a group deployment component (such as the server group deployment component 320S of FIG. 3). As mentioned earlier, group deployment component 320S receives the update parameters from group-wise deployment interface module 408 of the software update engine (see FIG. 4). Within group deployment component 320S, there is shown a group deployment interface module 502, representing the interface logic block for receiving the update parameters via the aforementioned group deployment protocol. Once the update parameters are received, group deployment interface module 502 may send a notification message back to notification module 308 in order to inform the system administrator of the status of the update process.

The received update parameters are passed onto a device-specific update processing, module 504, which performs the logistics associated with forwarding the update parameters to the specific target networked device. The updated parameters are sent via the network to the specific target network device using a device-wise deployment interface module 506, which represents the interface logic block for communicating with the local update agents disposed at the individual networked devices.

As in the case with the group-wise deployment interface module 408, tile device-wise deployment interface module 506 also employs a protocol in its communication. Thus, a device deployment protocol is implemented, which allows device-wise deployment interface module 506 to communicate via the network to the individual local update agents disposed at the individual networked devices. The use of the device deployment protocol enhances modularity, reliability and flexibility in that any local update agent may interoperate with any group deployment component through the network as long as both conform to the device deployment protocol and all error in one of the local update agents does not impact other local update agents or other parts of the automatic software updating system.

Since the update parameters are transmitted from the group deployment component (such as 320S of FIG. 5) to specific networked devices across the network, a network protocol may also be employed. In one embodiment, the transmittal of the update parameters across the network is accomplished using the Simple Network Management Protocol (SNMP) although any suitable network protocol may be employed.

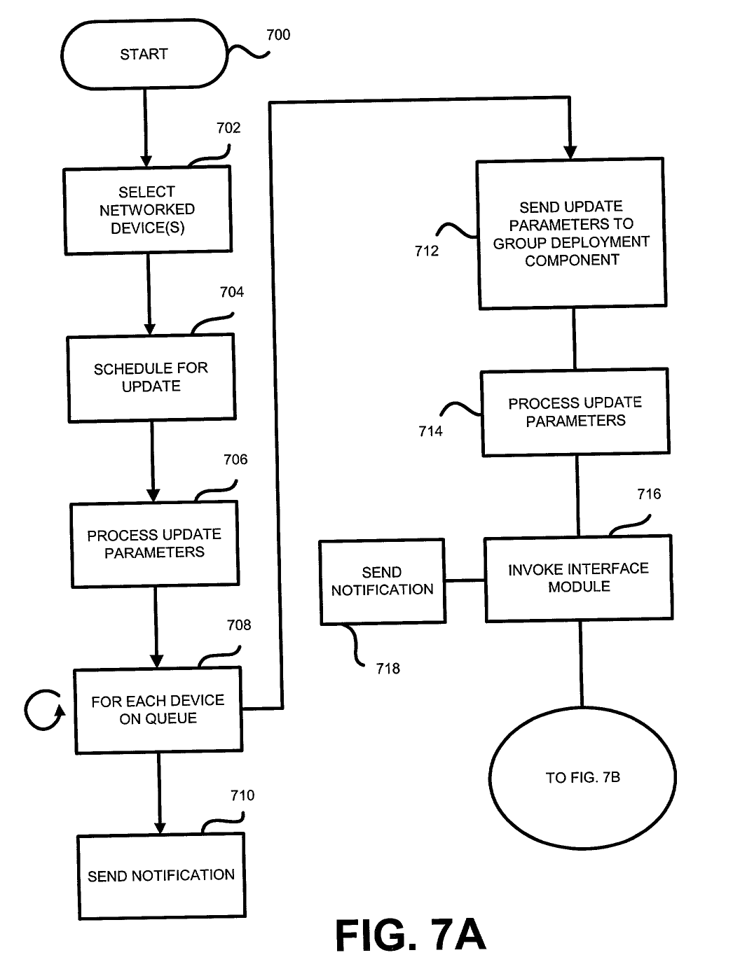

FIG. 6 illustrates, in one embodiment of the present invention, the more relevant modules of a local update agent disposed within the target networked device (such as local update agent 336 of server 330 in FIG. 3). Within local update agent 336, there is shown an interface module 602, representing the interface logic block for receiving from the group deployment component (such as group deployment component 320S of FIG. 3) the necessary update parameters. As mentioned before, the update parameters may be transmitted using a device deployment protocol and/or an appropriate network protocol such as SNMP. Once the update parameters are received, interface module 502 may send a notification message back to notification module 308 of the software update engine in order to inform the system administrator of the status of the update process.

The received update parameters are passed onto a local update processing module 604. Local update processing module 604 may then employed the received update parameters to access the update file(s) from either a shared location in the network or on the Internet, download the update files(s) if necessary, and commence execution of the update installation process. In one embodiment, the update files(s) are stored on a shared storage device coupled to the network and are accessed by their path name(s), which may be received as part of the update parameters. In another embodiment, the update file(s) are accessed by their URL (Uniform Resource Locator), which may be received as part of the update parameters and downloaded using the HTTP protocol. Depending on the specifics of an update process, which may be indicated in the update parameters and/or the actual update file(s), local update processing module 604 may also perform rebooting after installation of the update files is completed. The rebooting instruction may be included in the update file(s), and may cause the local update processing module to, for example, make the necessary system calls to cause reboot to occur after the installation is completed.

Furthermore, local update processing module may also send status data back in order to apprise the software upgrade engine and/or the system administrator of the status of the update. If the update is successful. the update parameters database (e.g., 310 in FIG. 3) is preferably updated with the status data sent back from local update agent 336 to reflect the successful update, other data associated with the successful update (such as the name of the update files, the time the update took place, and the like) as well as the latest version number of the updated software component.

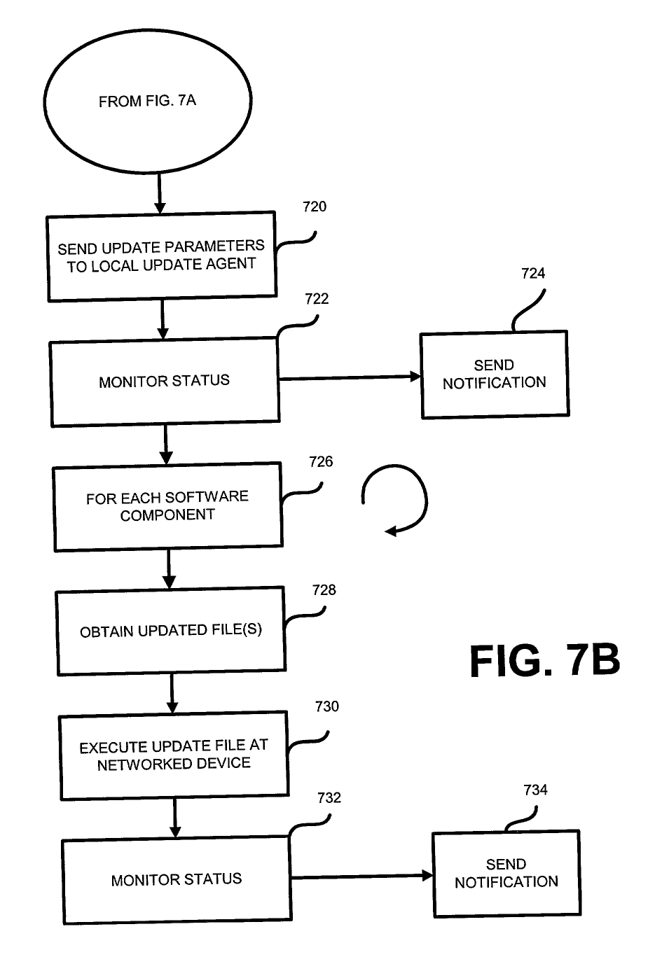

FIGS. 7A and 7B are flowcharts illustrating, in accordance with one embodiment of the present invention, the steps involved in automatically updating network software components. In step 702, the system administrator may select and/or filter the network devices to be updated. In step 704, the selected network devices are scheduled. In step 706, the software update engine processes the data from the update parameters database and the schedule. As mentioned, the update parameters database contains parameters pertaining to the identity of the software components to be updated, the associated network devices, the update file(s), and the like. The processing in step 706 prepares the sets of update parameters for queuing when the scheduled time arrives for the update to be performed.

In steps 708 and subsequent steps are taken for each set of update parameters or each networked device or each software component in the queue. In step 710, a notification message is sent to the notification module. This notification message may relate to the fact that an update has been initiated for the software component or it may reflect the status information passed back from the local update agent or the group deployment component.

In step 712, the update parameters are transmitted to the appropriate group deployment component using the group deployment protocol. Also during step 712, another notification message may be transmitted to the notification module to keep the system administrator apprised of the update progress.

In step 714, the update parameters are processed to ascertain the appropriate target networked device to which the update parameters may be transmitted. In step 716, the device-wise deployment interface module (such as 506 in pig. 5) is invoked to facilitate the transmittal of the update parameters to the local update agent disposed at the target networked device. If the invocation is successful, a notification message may be sent to the notification module (step 71 8). Thereafter, the update parameters are forwarded to the local update agent using the device deployment protocol.

FIG. 7B shows a step 720, representing the step for transmitting the update parameters to the local update agent using the device deployment protocol. For each software component to be updated, the status is monitored (step 722) from the status data passed back from the local update agent. Relevant status information is passed back to the notification module to keep the system administrator apprised of the update progress (step 724).

The update parameters are passed to the target networked device and are employed by the local update component at the targeted networked device in order to accomplish the updating task. Step 726 and subsequent steps are performed for each software component that requires updating as specified in the received update parameters.

In step 728, the appropriate update data file is obtained and/or downloaded using the received update parameters. In step 730, the obtained update data file is executed and the networked device is optionally rebooted to allow the updated changes to take effect. In block 732, the update progress is monitored by the local update agent and status data pertaining thereto is passed back (step 734) to the monitoring module to update the update information file and to keep the system administrator apprised as appropriate.

While this invention has been described in terms of several preferred embodiments, there are alterations. permutations, and equivalents which fall within the scope of this invention. It should also be noted that there are manly alternative ways of implementing the methods and apparatuses of the present invention. It is therefore intended that the following appended claims be interpreted as including all such alterations, permutations and equivalents as fall within the true spirit and scope of the present invention.

What is claimed is:

1. A computer-implemented method for updating a plurality of software components disposed on a plurality of networked devices, said plurality of networked devices being interconnected in a computer network, comprising:
ascertaining from a database first update parameters associated with a first networked device of said plurality of networked devices;
sending via said network said first update parameters to a first local update agent disposed at said first networked device;
obtaining, using said first local update agent and said first update parameters, a first update file for updating software in said first networked device; and
updating, using said first local update agent and said first update file, said software in said first networked device.

2. The method of claim 1 wherein said updating said software in said first networked device includes rebooting said first networked device, using said first local update agent, after said first update file is installed in said first networked device.

3. The method of claim 1 wherein said obtaining said first update file includes downloading said first update file via the Internet.

4. The method of claim 1 further including ascertaining a schedule for updating said first networked device, said sending said first update parameters to said first networked device is performed at a time indicated by said schedule.

5. The method of claim 1 wherein said database includes update parameters associated with said plurality of networked devices.

6. The method of claim 1 further including ascertaining from said database second update parameters associated with a second networked device of said plurality of networked devices;
sending via said network said second update parameters to a second local update agent disposed at said second networked device;
obtaining, using said second local update agent and said second update parameters. a second update file for updating software in said second networked device; and
updating, using said second local update agent and said second update file, said software in said second networked device.

7. The method of claim 6 wherein said sending said second update parameters occurs irrespective of when said updating said software in said first networked device is completed.

8. The method of claim 7 wherein said second update parameters and said first update parameters are sent from a single networked device.

9. The method of claim 8 further comprising:
receiving status information associated with said updating said software in said first networked device and said updating said software in said second networked device; and
updating said database with said status information.

10. The method of claim 9 wherein said status information includes respective latest version numbers of said software in said first networked device and said software in said second networked device after said updating said software in said first networked device and said updating said software in said second networked device if said updating said software in said first networked device and said updating said software in said second networked device are successful.

11. An arrangement for updating a plurality of software components disposed on a plurality of networked devices, said plurality of networked devices being interconnected in a computer network, comprising:
a database for storing update parameters associated with said plurality of networked devices, said update parameters including at least a name for a first one of said plurality of software components and a version number associated with said name for said first one of said plurality of software components;
a plurality of local update agents, each of said plurality of local update agents being disposed at one of said plurality of networked devices; and
a software update engine configured to send individual sets of said update parameters to individual ones of said plurality of local update agents at said plurality of network devices, wherein a first one of said plurality of local update agents disposed at a first one of said plurality of networked devices is configured to obtain, upon receiving a first one of said individual sets of said update parameters, a first update file using said first one of said individual sets of update parameters, said first update file representing a file containing data for updating said first one of said plurality of software components disposed at said first one of said plurality of networked devices.

12. The arrangement of claim 11 wherein a second one of said plurality of local update agents disposed at a second one of said plurality of networked devices is configured to obtain, upon receiving a second one of said individual sets of said update parameters, a second update file using said second one of said individual sets of update parameters, said second update file representing a file containing data for updating) a second one of said plurality of software components disposed at said second one of said plurality of networked devices.

13. The arrangement of claim 12 wherein said first one of said plurality of networked devices is one of a printer, a desktop computer. a laptop computer, and said second one of said plurality of networked devices is a different one of said printer, said desktop computer, and said laptop computer.

14. The arrangement of claim 12 further comprising a schedule for storing first update time for said first one said software components and second update time for said second one of said software components, said first one of said individual sets of update parameters and said second one of said individual sets of update parameters being sent automatically by said software update engine to said first one of said plurality of local update agents and said second one of said plurality of local update agents without human intervention at said first update time and said second update time respectively.

15. The arrangement of claim 12 further comprising a group deployment component disposed between said software update engine and both said first one of said plurality of local update agents and said second one of said plurality of local update agents, said group deployment component representing a distribution mechanism for a group of network devices of the same type.

16. The arrangement of claim 15 wherein said software update engine and said group deployment component are disposed at a centralized administrator computer.

17. An arrangement for updating a plurality of software components disposed on a plurality of networked devices, said plurality of networked devices being interconnected in a computer network, comprising:
a database for storing update parameters associated with said plurality of networked devices, said update parameters including at least a name for a first one of said plurality of software components and a version number associated with said name for said first one of said plurality of software components;
a plurality of local updating means, each of said plurality of local updating means being disposed at one of said plurality of networked devices; and
distribution means configured to send individual sets of said update parameters to individual ones of said plurality of local updating means at said plurality of network devices, wherein a first one of said plurality of local updating means disposed at a first one of said plurality of networked devices is configured to obtain, upon receiving a first one of said individual sets of said update parameters, a first update file using said first one of said individual sets of update parameters, said first update file representing a file containing data for updating said first one of said plurality of software components disposed at said first one of said plurality of networked devices.

18. The arrangement of claim 17 wherein a second one of said plurality of local updating means disposed at a second one of said plurality of networked devices is configured to obtain, upon receiving a second one of said individual sets of said update parameters, a second update file using said second one of said individual sets of update parameters, said second update file representing a file containing data for updating a second one of said plurality of software components disposed at said second one of said plurality of networked devices.

19. The arrangement of claim 18 wherein said first one of said plurality of networked devices is one of a printer, a desktop computer, a laptop computer, and said second one of said plurality of networked devices is a different one of said printer, said desktop computer, and said laptop computer

20. The arrangement of claim 18 further comprising a schedule for storing first update time or said first one said software components and second update time for said second one of said software components, said first one of said individual sets of update parameters and said second one of said individual sets of update parameters being sent automatically by said software update engine to said first one of said plurality of local updating means and said second one of said plurality of local updating means without human intervention at said first update time and said second update time respectively.

21. The arrangement of claim 18 wherein said first update file is obtained from the Internet by said first local updating, means using a URL (Uniform Resource Locator) specified in said first one of said individual sets of update parameters.

22. The arrangement of claim 18 wherein said first update file is obtained from a shared location in said network by said first local updating means using a path name specified in said first one of said individual sets of update parameters.
